(19) United States
(12) Patent Application Publication
(10) Pub. No.: US 2024/0249245 A1
(43) Pub. Date: Jul. 25, 2024

(54) SYSTEM AND METHOD OF PROJECT MANAGEMENT FOR PRODUCT INSTALLATION

(71) Applicant: ToniAnn Magadino, Old Bethpage, NY (US)

(72) Inventor: ToniAnn Magadino, Old Bethpage, NY (US)

(21) Appl. No.: 18/421,564

(22) Filed: Jan. 24, 2024

Related U.S. Application Data
(60) Provisional application No. 63/441,023, filed on Jan. 25, 2023.

(51) Int. Cl. G06Q 10/10; G06Q 10/1093

(52) U.S. Cl. CPC G06Q 10/103; G06Q 10/1095

(57) ABSTRACT

A computer-implemented method of project management for product installation includes scanning an area in which at least one material is to be installed during an appointment time with an estimator to generate a digital map of the area. A project design is generated including parameters for the selected material to be installed and a visual representation of the material to be installed. The visual representation of the material to be installed is overlayed onto the generated digital map of the area to generate a product installation blueprint. Materials or secured and a product installation cost is determined. The product installation cost includes a cost for acquiring the selected material, a cost for installing the selected material, and a service cost associated with generating the project design. A digital contract is generated for communication to the customer. The digital contract includes the product installation blueprint and a price quote.

### CROSS-REFERENCE TO RELATED APPLICATION

The present application claims priority to U.S. provisional patent application No. 63/441,023, filed Jan. 25, 2023, the disclosure of which is incorporated by reference herein.

### FIELD

The present disclosure relates to product installation and, more particularly, to a system and method of project management for product installation.

### BACKGROUND

Project management, particularly in the areas of materials installation, can be challenging. For example, fence or other construction material installation involves many management challenges from an initial planning phase, ordering materials, accurate installation and pricing/payment. Project management involves a process of leading the work of a team to achieve project goals within a particular budget and given time constraints.

As an example, construction management involves the coordinated work of many individuals and teams to achieve a desired project outcome. Coordinating project design, materials acquisition, delivery, pricing, installation and payment often involves the use of many disparate systems and processes. There remains an unmet need for an integrated system configured to manage and coordinate all phases of a construction project from design through final product installation and financial management of the project and payment of all parties involved.

### SUMMARY

Provided in accordance with aspects of the present disclosure is a computer-implemented method of project management for product installation including comparing a requested appointment time for a customer with available appointment times for an estimator and scheduling an appointment time between the estimator and the customer. The method includes scanning an area in which at least one material is to be installed during the appointment time. Scanning the area includes generating a digital map of the area. Through an interaction between the customer and the estimator, a project design is generated. The project design includes the parameters for the selected material to be installed and a visual representation of the material to be installed. The visual representation of the material to be installed is overlayed onto the generated digital map of the area to generate a product installation blueprint. The method includes generating an order for acquiring the selected material. The generated order includes an acquisition order for acquiring the material from materials stored in a storage facility or a purchase order for ordering the material from a third party. The method includes determining a product installation cost. The product installation cost includes a cost for acquiring the selected material, a cost for installing the selected material, and a service cost associated with generating the project design. The method includes generating a price quote for communication to the customer. A digital contract is generated for communication to the customer. The digital contract includes the product installation blueprint and the price quote.

In an aspect of the present disclosure, the material to be installed includes fencing.

In an aspect of the present disclosure, the method includes generating an installation schedule including tasks to be performed. The installation schedule is determined based on availability of an installation crew. The digital contract includes a listing of the tasks to be performed.

In an aspect of the present disclosure, a notification is sent to the customer each time a task is completed.

In an aspect of the present disclosure, the parameters for the material to be installed are selected from a drop-down tab providing a list of parameter options.

In an aspect of the present disclosure, scheduling the appointment time between the estimator and the customer includes cross-referencing the requested appointment time by a zip code of the estimator and a zip code of the estimator and transit time to the area in which the material is to be installed for the estimator from the zip code of the estimator to the zip code of the customer.

In an aspect of the present disclosure, the digital contract is a non-fungible token (NFT) authenticated using a blockchain.

In an aspect of the present disclosure, the product design is updated, and an updated product installation blueprint is generated. Generating the updated product installation blueprint triggers a generation of an updated digital contract. The updated digital contract includes the updated product installation blueprint.

In an aspect of the present disclosure, the updated digital contract is an updated NFT authenticated by the blockchain.

In an aspect of the present disclosure, the method includes tracking a location of the estimator, a field manager or an installation crew.

In an aspect of the present disclosure, scanning the area in which a material is to be installed during the appointment time includes taking images using a digital camera and converting the digital images into a 3-dimensional (3D) model of the area in which the material is to be installed.

In an aspect of the present disclosure, the visual representation of the selected material to be installed is overlayed onto the 3D model to generate the product installation blueprint.

In an aspect of the present disclosure, images are captured using a drone supporting a digital camera.

In an aspect of the present disclosure, the digital camera is an integrated device housed in a smartphone, tablet computer or laptop computer.

In an aspect of the present disclosure, the generated digital map of the area is compared with a publicly available map of the area.

In an aspect of the present disclosure, the method includes calculating a required linear amount of the selected material to be installed.

In an aspect of the present disclosure, calculating the required linear amount of the selected material to be installed includes adding an amount of waste material.

In an aspect of the present disclosure, the method is performed by a computer program product including a non-transitory computer readable storage medium having program instructions embodied therewith. The program instructions are executable by a processor to cause the processor to perform the steps of the method.

In an aspect of the present disclosure, a system for managing product installation including a back office module configured to compare a requested appointment time for a customer with available appointment times for an estimator and scheduling an appointment time between the estimator and the customer. An estimator module is configured to scan an area in which a material is to be installed during the appointment time. Scanning the area includes generating a digital map of the area. The estimator module generates a project design. The project design includes parameters for the selected material to be installed and a visual representation of the selected material to be installed. The estimator module is configured to overlay the visual representation of the material to be installed onto the generated digital map of the area to generate a product installation blueprint. A project material and cost calculation module generates an order for acquiring the selected material. The generated order includes an acquisition order for acquiring the selected material from materials stored in a storage facility or a purchase order for ordering the material from a third party. The project material and cost calculation module determines a product installation cost. The product installation cost includes a cost for acquiring the selected material, a cost for installing the selected material, and a service cost associated with generating the project design. The project material and cost calculation module generates a price quote for communication to the customer. The price quote includes the product installation cost. A contract management module generates a digital contract for communication to the customer. The digital contract includes the product installation blueprint and the price quote.

In an aspect of the present disclosure, a progress calculation module generates an installation schedule including the tasks to be performed, wherein the installation schedule is determined based on availability of an installation crew.

In an aspect of the present disclosure, an NFT control module converts the digital contract into a NFT authenticated using a blockchain.

In an aspect of the present disclosure, a GPS tracking module tracks a location of the estimator, a field manager or an installation crew.

In an aspect of the present disclosure, a drone supports a digital camera, and the images are captured using the digital camera supported by the drone.

In an aspect of the present disclosure, the digital camera is an integrated device housed in a smartphone, tablet computer or laptop computer.

In an aspect of the present disclosure, a material usage database stores data of amounts of waste material generated.

### BRIEF DESCRIPTION OF THE DRAWINGS

Various aspects and features of the present disclosure are described hereinbelow with reference to the drawings wherein:

FIG. 1 is a schematic diagram of a system for managing product installation according to aspects of the present disclosure;

FIG. 2 is an expanded view of the back office module of the system of FIG. 1;

FIG. 3 is an expanded view of the customer portal of the system of FIG. 1;

FIG. 4 is an expanded view of the contract management module of the system of FIG. 1;

FIG. 5 is an expanded view of the estimator portal of the system of FIG. 1;

FIG. 6 is an expanded view of the project material and cost calculation module of the system of FIG. 1;

FIG. 7 illustrates a product installation blueprint overlayed on a digital map of an area to which a material is to be installed;

FIG. 8 illustrates an exemplary digital contract including the product installation blueprint;

FIG. 9 is a flow chart of a method of managing product installation according to aspects of the present disclosure; and

FIG. 10 is a block diagram of an exemplary computer for managing product installation according to aspects of the present disclosure.

### DETAILED DESCRIPTION

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

Exemplary configurations of the disclosure will be described more fully below (e.g., with reference to the accompanying drawings). Like reference numerals may refer to like elements throughout the specification and drawings.

Each module described herein may have its own unique general purpose computer including at least a processor and a memory configured to store computer instructions executable by the processor to perform the corresponding functions of the particular module. Alternatively, or in conjunction with having its own unique general purpose computer, each module may interact with a remote general purpose computer having at least a processor and a memory. As an example, the remote general purpose computer may be accessed through a cloud or internet connection.

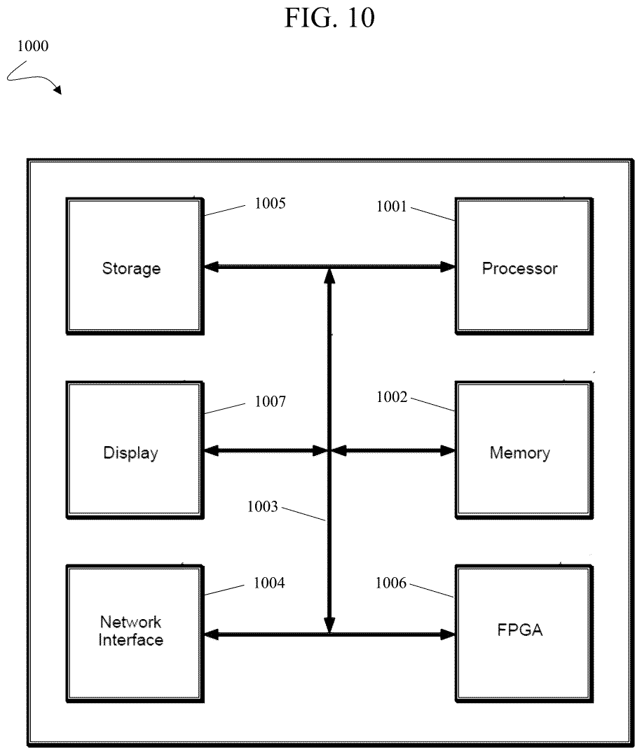

As an example, the general purpose computers (see, e.g., computer 1000 in FIG. 10) described herein may be embodied in a smartphone, tablet computer, desktop computer or laptop computer.

While many specific examples are provided employing the systems and methods described herein to installation of residential or commercial fencing, the systems and methods described herein can be similarly employed for other types of projects, such as woodworking, roofing, plumbing, contracting, electrical work, masonry, landscaping, etc.

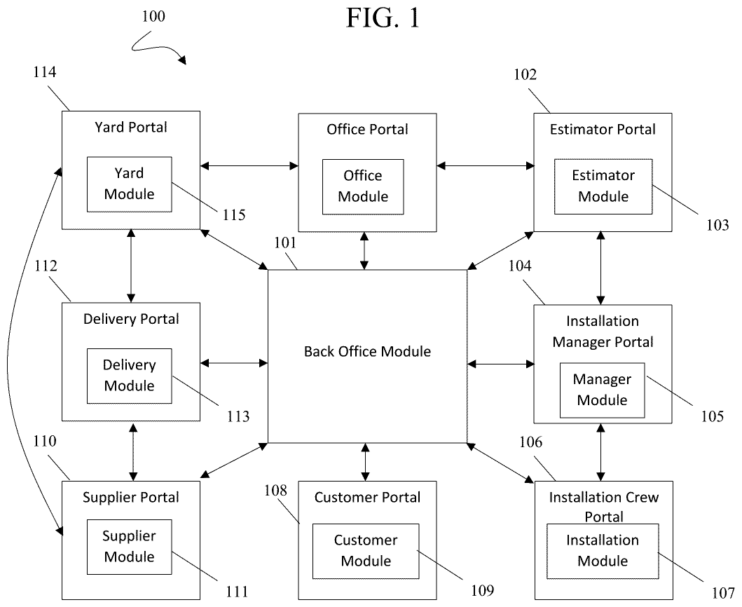

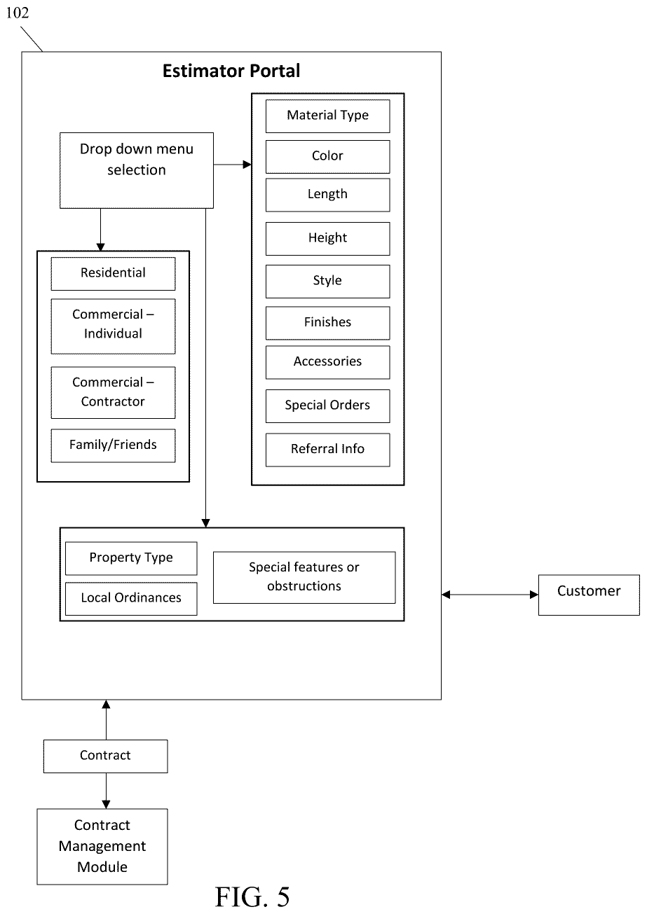

Referring generally to FIGS. 1-10, a computer-implemented method of project management for product installation includes comparing a requested appointment time for a customer with available appointment times for an estimator and scheduling an appointment time between the estimator and the customer. Geographic and time considerations are employed for matching a customer's appointment requests with an estimator who is available to meet the customer on-site. The estimator employs an estimator portal 102 that interfaces with an estimator module (e.g., a portal having a user interface displayed on a smartphone, tablet computer, or laptop computer) during the appointment.

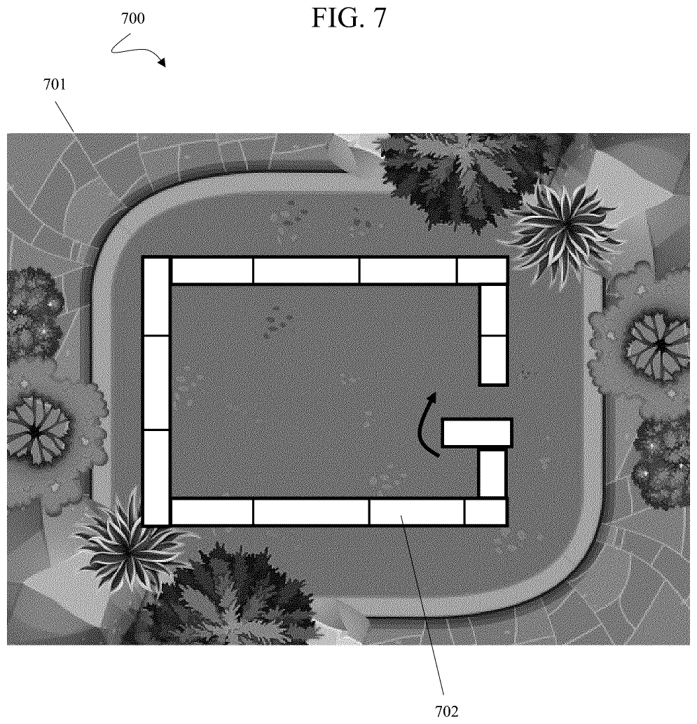

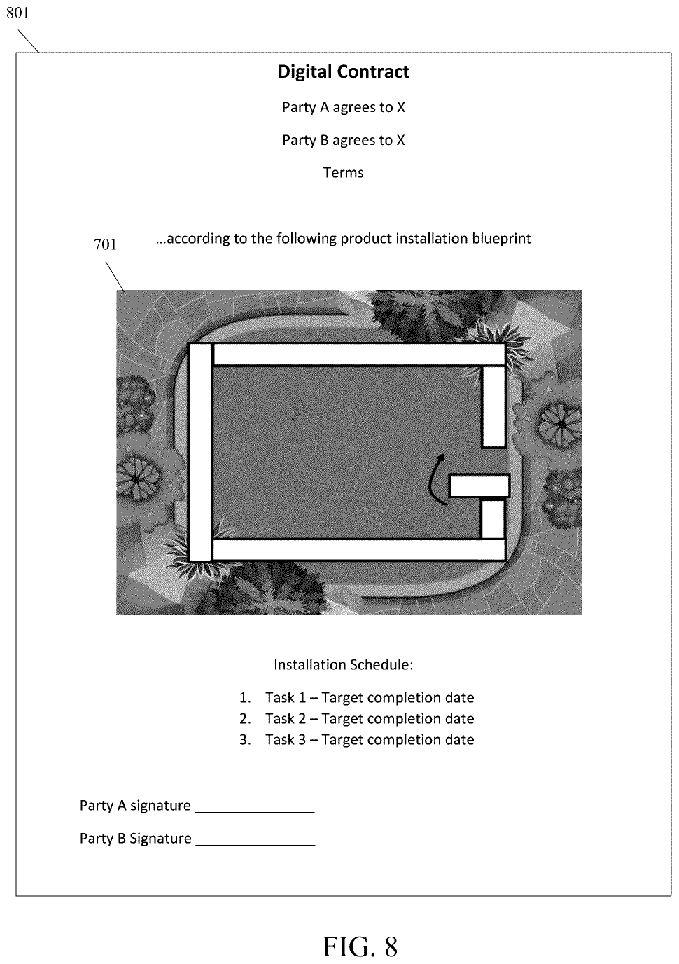

When an estimator and customer meet, an area in which at least one material is to be installed is reviewed and digitally scanned (e.g., by using a digital camera). Scanning the area in which a product (e.g., fencing, gates, etc.) will ultimately be installed includes generating a digital map (see, e.g., map 701 in FIG. 7) of the area. The digital map can be marked up or otherwise used to display what a product installation will ultimately look like. Through an interaction between the customer and the estimator, a project design is generated. The project design includes the parameters for the selected material to be installed and a visual representation of the material to be installed. The parameters may include, for example and without limitation, material type, color, height(s), width(s) style, presence and option for caps/finishes, gates, specialty items. The visual representation of the material to be installed is overlayed onto the generated digital map of the area to generate a product installation blueprint (see, e.g., blueprint 702 in FIGS. 7 and 8). The product installation blueprint provides the customer with a visual presentation of what project design will actually look like when complete in the customer's unique space.

In an aspect of the present disclosure, scanning the area in which a material is to be installed during the appointment time includes taking images using a digital camera and converting the digital images into a 3-dimensional (3D) model of the area in which the material is to be installed. The visual representation of the selected material to be installed can be overlayed onto the 3D model to generate the product installation blueprint.

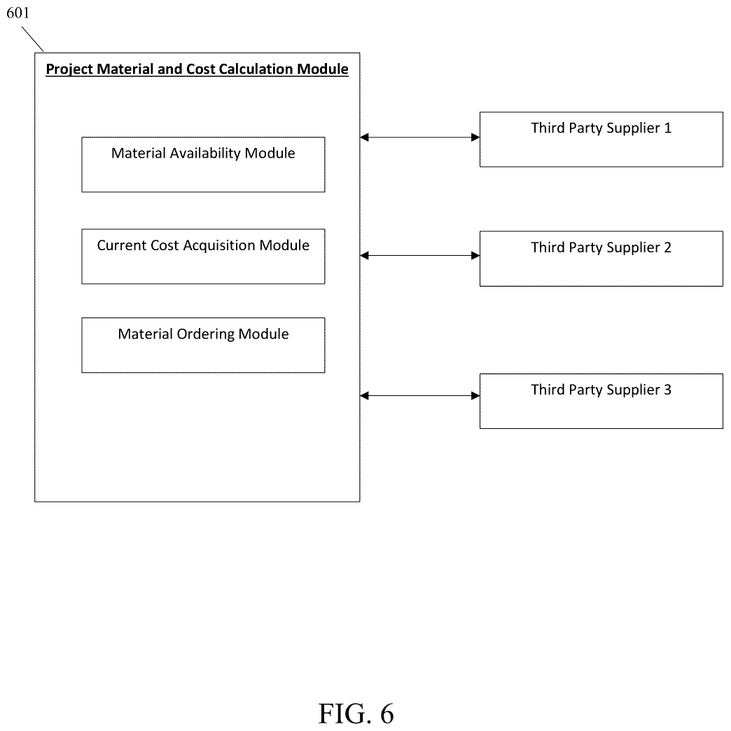

The method includes generating an order for acquiring the selected material. The location of available materials may include materials already in-stock and held by the entity managing the material installation and/or the materials may need to be ordered. Thus, one or both of securing in-stock materials and assigning them for use in a particular job and/or ordering materials from a third party may be employed to acquire the materials necessary for completing a project. For example, the generated order can include an acquisition order for acquiring the material from materials stored in a storage facility or a purchase order for ordering the material from a third party. After in-stock materials are assigned to a particular project, they would appear in the system described herein as unavailable for other projects. The system/method described herein may also trigger an order to generate a pallet including the selected materials for shipment to a job site. Ordering materials from a third party allows for immediate checking of material pricing and locking in a price from one of a multitude of suppliers (see, e.g., FIG. 6).

The method includes determining a product installation cost. The product installation cost includes a cost for acquiring the selected material, a cost for installing the selected material, and a service cost associated with generating the project design. A price quote including al pricing for a project is ultimately generated for communication to the customer. A digital contract (see, digital contract 801 e.g., FIG. 8) is generated for communication to the customer. The digital contract includes the product installation blueprint and the price quote. The digital contract can be dynamically updated, as described herein. Automatically generating a digital content that includes details of a project provides a way to conveniently and efficiently deliver a clearly communicated plan to a customer and to memorialize any changes to the plan with an updated digital contract.

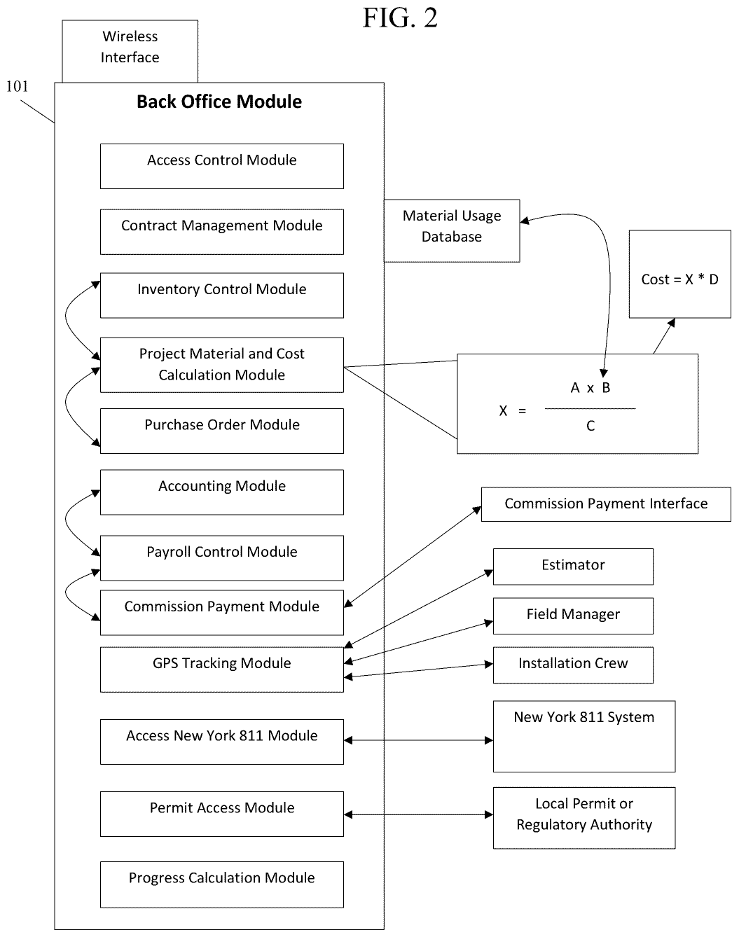

Referring particularly to FIGS. 1-2, as an example, determining the product installation cost (e.g., for a fencing installation) may be performed according to formula illustrated in FIG. 2 in which X is total amount of material needed for completing a project design multiplied by D (where D is the cost per unit of the material). The total amount (e.g., number of units) of material (X) is determined by multiplying a total linear feet of material needed (A) by a waste factor (B) and dividing by a linear footage per item of material (C). Waste factor (B) may be acquired from a material usage database that stores data of an average waste usage of each particular type of item to be installed. As an example, (B) may range from a value of 1.05 to 1.33. The amount of waste per item to be installed may vary by the type of item. For example, wood fencing may have little to no waste and thus value (B) would be relatively low. Alternatively, a metal fencing may have a relatively large amount of waste and thus value (B) would be relatively high.

An installation schedule including tasks to be performed and estimated times/dates is generated. The installation schedule is determined based on availability of an installation crew. The digital contract includes a listing of the tasks to be performed. Any updates to the installation schedule can be populated into a new and unique digital contract, as described herein.

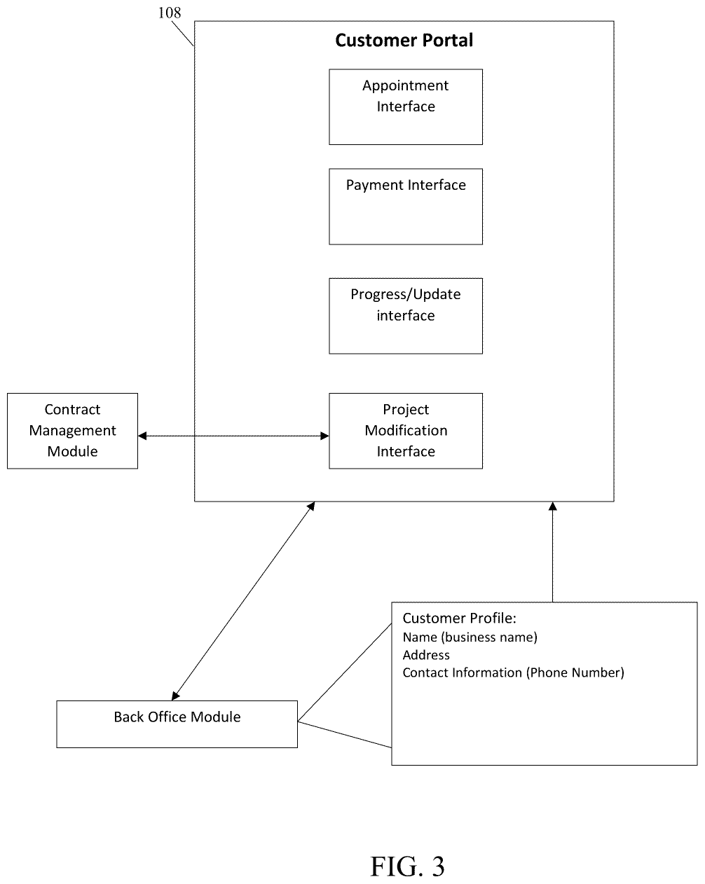

In an aspect of the present disclosure, a notification is sent to the customer each time a task is completed. Customers may request changes or receive updates in a customer portal (see, e.g., FIG. 3).

As an example, the parameters for the material to be installed are selected from a drop-down tab providing a list of parameter options. As discussed herein, the parameters may include the style, material type, color, height, etc. for an item to be installed. Naturally, a plurality of different materials may ultimately be installed and therefore any product installation blueprint that is generated may include a list of different types and materials and corresponding quantities of each material.

Scheduling the appointment time between the estimator and the customer may include cross-referencing the requested appointment time by a zip code of the estimator and a zip code of the estimator and transit time to the area in which the material is to be installed for the estimator from the zip code of the estimator to the zip code of the customer.

A non-fungible token (NFT) is a distinct representation of assets or goods stored on a digital ledger, called a blockchain. A blockchain is a secure data platform that certifies the uniqueness of a digital asset and may employ smart contract functionality. NFTs are referred to as ‘Non-Fungible’ because they cannot be directly exchanged with another NFT due to their unique digital signature. NFTs can be associated with reproducible digital files such as photos, videos, audio files, or other documents (e.g., contracts). NFTs employ a digital ledger to provide a public certificate of authenticity and/or proof of ownership.

In an aspect of the present disclosure, the digital contract is a NFT authenticated using a blockchain. The benefits of converting a contract to an NFT is the ability to authenticate and easily update a digital contract. The product design may be updated at any point during the planning or execution of a product installation and an updated product installation blueprint can be generated with each update. Generating the updated product installation blueprint triggers a generation of an updated digital contract. The updated digital contract includes the updated product installation blueprint. The updated digital contract is an updated NFT authenticated by the blockchain.

The system and method described herein may include tracking a location of the estimator, a field manager or an installation crew. This allows matching of available personnel with customer needs in a dynamic manner throughout the course of a project.

In an aspect of the present disclosure, multiple images are captured using a drone supporting a digital camera. The use of a drone allows the digital camera to capture a top plan/aerial view of a project site. Alternatively, the digital camera is an integrated device housed in a smartphone, tablet computer or laptop computer.

In an aspect of the present disclosure, the generated digital map of the area can be compared with a publicly available map of the area. The publicly available map may provide information about power lines, underground lines, or other obstructions that should be avoided. Publicly available property lines may also be displayed by a publicly available map, thus avoiding installation of a material in an undesired areas.

In an aspect of the present disclosure, each step of the method described herein is performed by a computer program product including a non-transitory computer readable storage medium having program instructions embodied therewith. The program instructions are executable by a processor to cause the processor to perform the steps of the method. The computer program product may be accessible on a cloud-based server. The computer program product may also be executed on a tablet computer, laptop computer or smartphone (or a combination of devices each having cloud or internet access).

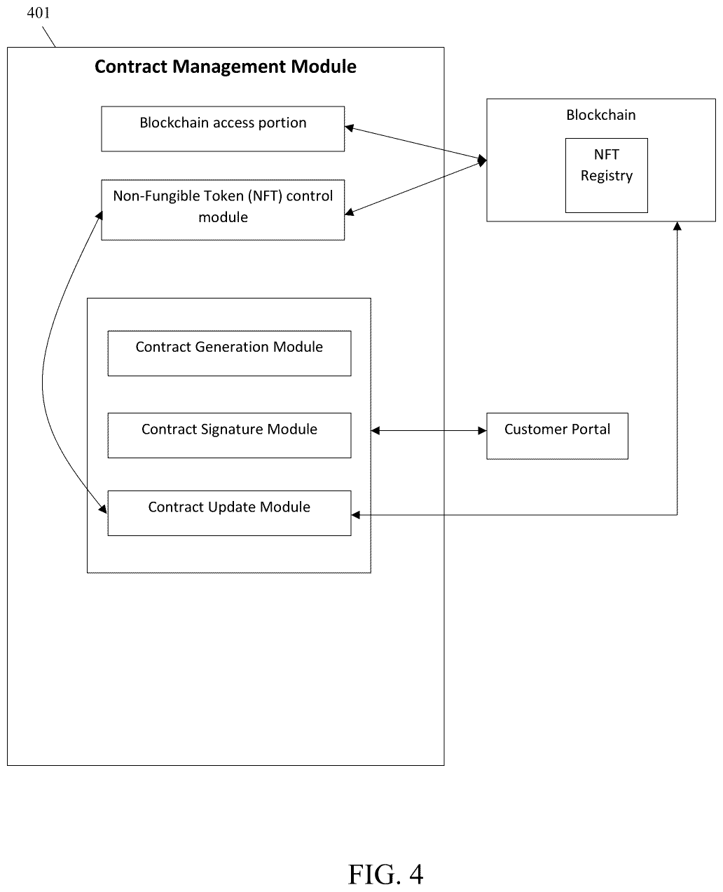

In an aspect of the present disclosure, a system 100 for managing product installation includes a back office module 101. The back office module 101 is configured to compare a requested appointment time for a customer with available appointment times for an estimator and scheduling an appointment time between the estimator and the customer. An estimator module 103 (see, e.g., estimator portal 102 in FIG. 1) is configured to scan an area in which a material is to be installed during the appointment time. Scanning the area includes generating a digital map (see, e.g., digital map 701 in FIG. 7) of the area. The estimator module 103 generates a project design (see, e.g., project design 700 including digital map 701 and overlayed blueprint 702 in FIG. 7). The project design includes parameters for the selected material to be installed and a visual representation of the selected material to be installed. The estimator module 703 is configured to overlay the visual representation of the material to be installed onto the generated digital map of the area to generate a product installation blueprint. A project material and cost calculation module (see, e.g., 601 in FIG. 6) generates an order for acquiring the selected material. The generated order includes an acquisition order for acquiring the selected material from materials stored in a storage facility or a purchase order for ordering the material from a third party. The project material and cost calculation module determines a product installation cost. The product installation cost includes a cost for acquiring the selected material, a cost for installing the selected material, and a service cost associated with generating the project design. The project material and cost calculation module generates a price quote for communication to the customer. The price quote includes the product installation cost. A contract management module (see, e.g., contract management module 401 in FIG. 4) generates a digital contract (see, e.g., digital contract 801 in FIG. 8) for communication to the customer. The digital contract includes the product installation blueprint and the price quote.

The project material and cost calculation module receives information about materials in inventory from an inventory control module (see, e.g., inventory control module of back office module 101 in FIG. 2). The project material and cost calculation module can interact with a purchase order module (see, e.g., purchase order module of back office module 101 in FIG. 2) to generate purchase orders for needed materials.

In an aspect of the present disclosure, a progress calculation module (see, e.g., progress calculation module of back office module 101 in FIG. 2) generates an installation schedule including the tasks to be performed. The installation schedule is determined based on availability of an installation crew.

In an aspect of the present disclosure, an NFT control module (see, e.g., NFT control module of contract control module 401 in FIG. 4) converts the digital contract into a NFT authenticated using a blockchain.

In an aspect of the present disclosure, a GPS tracking module (see, e.g., GPS tracking module of back office module 101 in FIG. 2) tracks a location of the estimator, a field manager or an installation crew.

In an aspect of the present disclosure, a drone supports a digital camera, and the images are captured using the digital camera supported by the drone.

In an aspect of the present disclosure, the digital camera is an integrated device housed in a smartphone, tablet computer or laptop computer.

In an aspect of the present disclosure, a material usage database stores data (see, e.g., FIG. 2) of amounts of waste material generated.

The system 100 is described in more detail below with reference to FIGS. 1 to 6, in particular. Any of the modules described below with reference to FIG. 1 may allow particular users or teams of users to engage with the back office module 101 via an interface, such as a web or application based interface, that is operated on a smartphone, tablet computer, laptop computer or desktop computer. Each particular type of user (e.g., estimator, manager, crew, customer, etc.) may have limited access to the functionality provided by their corresponding module and/or portal. For example, a customer would not be provided information related to suppliers or the activities of a materials yard, in part because such information would likely not be relevant to a customer.

Referring particularly to FIGS. 1 to 6, the system 100 may include an installation manager portal 104 to allow the back office module 101 to interact with an installation manager. The installation manager may engage with system 100 via a manager module 105 (e.g., an application operating on a smartphone or tablet computer).

The system 100 may include an installation crew portal 106 to allow members of an installation crew to interact with the back office module 101. The installation manager portal 106 may include an installation module 107 (e.g., an application operating on a smartphone or tablet computer).

The system 100 may include a customer portal 108 to allow customers to interact with the back office module 101. The customer portal 108 may include a customer module 109 (e.g., an application operating on a smartphone or tablet computer).

The system 100 may include a supplier portal 110 to allow suppliers (e.g., materials suppliers) to interact with the back office module 101. The supplier portal 110 may include a supplier module 111 (e.g., an application operating on a smartphone or tablet computer).

The system 100 may include a delivery portal 112 to allow a delivery crew (e.g., drivers of delivery vehicles) to interact with the back office module 101. The delivery portal 112 may include a delivery module 112 (e.g., an application operating on a smartphone or tablet computer).

The system 100 may include a yard portal 114 to allow a crew working in a yard, such as a yard for storing or packaging materials to interact with the back office module 101. The delivery yard portal 114 may include a yard module 115 (e.g., an application operating on a smartphone or tablet computer).

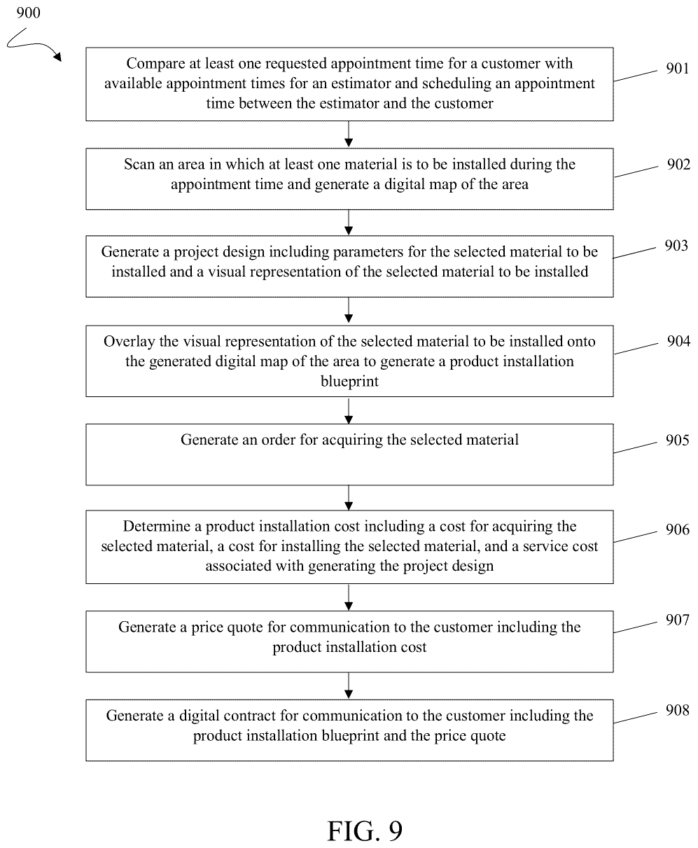

FIG. 9 is a flow chart of an exemplary computer-implemented method 900 of managing product installation. Method 900 includes comparing at least one requested appointment time for a customer with available appointment times for an estimator and scheduling an appointment time between the estimator and the customer (step 901). Method 900 includes scanning an area in which at least one material is to be installed during the appointment time and generating a digital map of the area (step 902). Method 900 includes generating a project design including parameters for the selected material to be installed and a visual representation of the selected material to be installed (step 903). Method 900 includes overlaying the visual representation of the selected material to be installed onto the generated digital map of the area to generate a product installation blueprint (step 904). Method 900 includes generating an order for acquiring the selected material (step 905). Method 900 includes determining a product installation cost including a cost for acquiring the selected material, a cost for installing the selected material, and a service cost associated with generating the project design (step 906). Method 900 includes generating a price quote for communication to the customer including the product installation cost (step 907). Method 900 includes generating a digital contract for communication to the customer including the product installation blueprint and the price quote (step 908).

Referring to FIG. 10, a general purpose computer 1000 is described. The general purpose computer 1000 can be employed by the system described herein and configured to execute the method described herein. The computer 1000 may include a processor 1001 connected to a computer-readable storage medium or a memory 1002 which may be a volatile type memory, e.g., RAM, or a non-volatile type memory, e.g., flash media, disk media, etc. The processor 1001 may be another type of processor such as, without limitation, a digital signal processor, a microprocessor, an ASIC, a graphics processing unit (GPU), field-programmable gate array (FPGA), or a central processing unit (CPU).

In some aspects of the disclosure, the memory 1002 can be random access memory, read-only memory, magnetic disk memory, solid state memory, optical disc memory, and/or another type of memory. The memory 1002 can communicate with the processor 1001 through communication buses 1003 of a circuit board and/or through communication cables such as serial ATA cables or other types of cables. The memory 1002 includes computer-readable instructions that are executable by the processor 1001 to operate the computer 1000 for managing product installation. The computer for managing product installation may include a network interface 1004 to communicate with other computers or a server. A storage device 1005 may be used for storing data. The computer 1000 may include one or more FPGAs 1006. The FPGA may be used for executing various machine learning algorithms. A display 1007 may be employed to display data processed by the computer 1000.

Referring generally to FIG. 1 again, the back office module is a central module interconnecting all other modules of the system.

A yard module can be employed for tracking available materials in a storage yard or storage facility and providing data of the materials to the back office module. The yard portal may be used to communicate material requests or orders (e.g., an order to prepare a pallet including particular materials) to persons working in the yard or storage facility. The yard module may communicate with a supplier portal to coordinate the ordering of materials from a third party supplier. The yard portal and supplier portal may each communicate with and coordinate delivery or materials to a job site. The office portal provides an interface for a management office to track all other behaviors of individuals interacting with the system (e.g., to track a new project arriving from an estimator or the track the delivery of materials to a job site). An installation manager can coordinate completion of a project by acting as a liaison between the estimator and the installation crew. The installation manager interfaces with the system through an installation manager portal and the installation crew interface with the system through an installation crew portal.

Referring particularly to FIG. 2, the back office module dynamically communicates with all other modules of the system through a wireless connection or wireless interface. All modules may ultimately be in either direct or indirect communication with the internet.

The back office module includes an access control module, which sets the access rules for all people interacting with the system. For example, an estimator would likely not have authorization to access information about payroll for the installation crew.

The back office module includes an accounting module configured to generate accounting reports such as yearly accounting reports. The accounting modules can communicate with commercially available software for easily generating and communicating any financial data for product installation projects.

The back office module includes a payroll control module for managing payments to anyone engaging with the system (e.g., payments to members of an installation crew). The commission payment module can be employed for calculating and paying commissions owed to an estimator.

A permit access module can be employed to communicate with local permit or regulatory authorities for obtaining and managing permits. For example, building permits from a local municipality can be obtained and stored by the permit access module. As an example, the New York 811 module can communicate with the New York 811 for identifying safe/permitted areas for digging or excavating.

It will be understood that various modifications may be made to the aspects and features disclosed herein. Therefore, the above description should not be construed as limiting, but merely as exemplifications of various aspects and features. Those skilled in the art will envision other modifications within the scope and spirit of the claims appended thereto.

What is claimed is:

1. A computer-implemented method of project management for product installation, comprising:
comparing at least one requested appointment time for a customer with available appointment times for an estimator and scheduling an appointment time between the estimator and the customer;
scanning an area in which at least one material is to be installed during the appointment time, wherein scanning the area includes generating a digital map of the area;
generating, by an interaction between the customer and the estimator, a project design, wherein the project design includes a plurality of parameters for the at least one selected material to be installed and a visual representation of at least one selected material to be installed;
overlaying the visual representation of the at least one selected material to be installed onto the generated digital map of the area to generate a product installation blueprint;
generating an order for acquiring the at least one selected material, wherein the generated order includes an acquisition order for acquiring the at least one selected material from a plurality of materials stored in a storage facility or a purchase order for ordering the at least one selected material from a plurality of materials sold by a third party;
determining a product installation cost, the product installation cost including a cost for acquiring the at least one selected material, a cost for installing the at least one selected material, and a service cost associated with generating the project design;
generating a price quote for communication to the customer, the price quote including the product installation cost; and
generating a digital contract for communication to the customer, the digital contract including the product installation blueprint and the price quote.

2. The computer-implemented method of claim 1, wherein the at least one material to be installed includes fencing.

3. The computer-implemented method of claim 1, further including:
generating an installation schedule including a plurality of tasks to be performed, wherein the installation schedule is determined based on availability of an installation crew, and
wherein the digital contract includes a listing of the plurality of tasks to be performed.

4. The computer-implemented method of claim 3, further including sending a notification to the customer each time a task of the plurality of tasks to be performed is completed.

5. The computer-implemented method of claim 1, wherein at least one parameter of the plurality of parameters for the at least one material to be installed is selected from a drop-down tab providing a plurality of parameter options.

6. The computer-implemented method of claim 1, wherein scheduling the appointment time between the estimator and the customer includes cross-referencing the at least one requested appointment time by a zip code of the estimator and a zip code of the estimator and transit time to the area in which the at least one material is to be installed for the estimator from the zip code of the estimator to the zip code of the customer.

7. The computer-implemented method of claim 1, wherein the digital contract is a non-fungible token (NFT) authenticated using a blockchain.

8. The computer-implemented method of claim 1, further including updating the product design and generating an updated product installation blueprint, wherein generating the updated product installation blueprint triggers a generation of an updated digital contract, the updated digital contract including the updated product installation blueprint.

9. The computer-implemented method of claim 8, wherein the updated digital contract is an updated NFT authenticated by the blockchain.

10. The computer-implemented method of claim 1, further including tracking a location of the estimator, a field manager or an installation crew.

11. The computer-implemented method of claim 1, wherein scanning the area in which at least one material is to be installed during the appointment time includes taking a plurality of images using a digital camera and converting the plurality of digital images into a 3-dimensional (3D) model of the area in which at least one material is to be installed.

12. The computer-implemented method of claim 11, wherein the visual representation of the at least one selected material to be installed is overlayed onto the 3D model to generate the product installation blueprint.

13. The computer-implemented method of claim 11, wherein the plurality of images are captured using a drone supporting the digital camera.

14. The computer-implemented method of claim 11, wherein the digital camera is an integrated device housed in a smartphone, tablet computer or laptop computer.

15. The computer-implemented method of claim 1, further including comparing the generated digital map of the area with a publicly available map of the area.

16. The computer-implemented method of claim 1, further including calculating a required linear amount of the at least one selected material to be installed.

17. The computer-implemented method of claim 16, wherein calculating the required linear amount of the at least one selected material to be installed includes adding an amount of waste material.

18. A computer program product comprising a non-transitory computer readable storage medium having program instructions embodied therewith, the program instructions executable by a processor to cause the processor to:
compare at least one requested appointment time for a customer with available appointment times for an estimator and scheduling an appointment time between the estimator and the customer;
scan an area in which at least one material is to be installed during the appointment time, wherein scanning the area includes generating a digital map of the area;
generate, by an interaction between the customer and the estimator, a project design, wherein the project design includes a plurality of parameters for the at least one selected material to be installed and a visual representation of at least one selected material to be installed;
overlay the visual representation of the at least one selected material to be installed onto the generated digital map of the area to generate a product installation blueprint;
generate an order for acquiring the at least one selected material, wherein the generated order includes an acquisition order for acquiring the at least one selected material from a plurality of materials stored in a storage facility or a purchase order for ordering the at least one selected material from a plurality of materials sold by a third party;
determine a product installation cost, the product installation cost including a cost for acquiring the at least one selected material, a cost for installing the at least one selected material, and a service cost associated with generating the project design;
generate a price quote for communication to the customer, the price quote including the product installation cost; and
generate a digital contract for communication to the customer, the digital contract including the product installation blueprint and the price quote.

19. The computer program product of claim 18, wherein the at least one material to be installed includes fencing.

20. The computer program product of claim 18, wherein the program instructions executable by the processor further cause the processor to:
generate an installation schedule including a plurality of tasks to be performed, wherein the installation schedule is determined based on availability of an installation crew, and
wherein the digital contract includes a listing of the plurality of tasks to be performed.
